(19) United States
(12) Patent Application Publication
(10) Pub. No.: US 2018/0239351 A1
(43) Pub. Date: Aug. 23, 2018

(54) AUTONOMOUS MOBILE DEVICE

(71) Applicant: HON HAI PRECISION INDUSTRY CO., LTD., New Taipei (TW)

(72) Inventor: CHIH-HUA LIANG, New Taipei (TW)

(21) Appl. No.: 15/854,655

(22) Filed: Dec. 26, 2017

(30) Foreign Application Priority Data
Feb. 22, 2017 (TW) 106105931

(51) Int. Cl. G05D 1/00; G05D 1/02; G01S 17/89; G01S 15/93; G01C 21/20

(52) U.S. Cl. CPC G05D 1/0038; G05D 1/0246; G05D 1/0274; G05D 1/0255; G01S 2015/937; G01S 17/89; G01S 15/931; G01C 21/20; G05D 1/0022

(57) ABSTRACT

A autonomous mobile device includes a body, two LiDAR devices, a CPU, a control terminal and an image detector. The body includes a front end and a back end. The two Light Detection and Ranging (LiDAR) devices are separately located on the front end and the back end. The CPU is used to control operation of two LiDAR devices. The control terminal is used to receive information from the CPU and control movement of the autonomous mobile device. The image detector is used to detect image information around the autonomous mobile device.

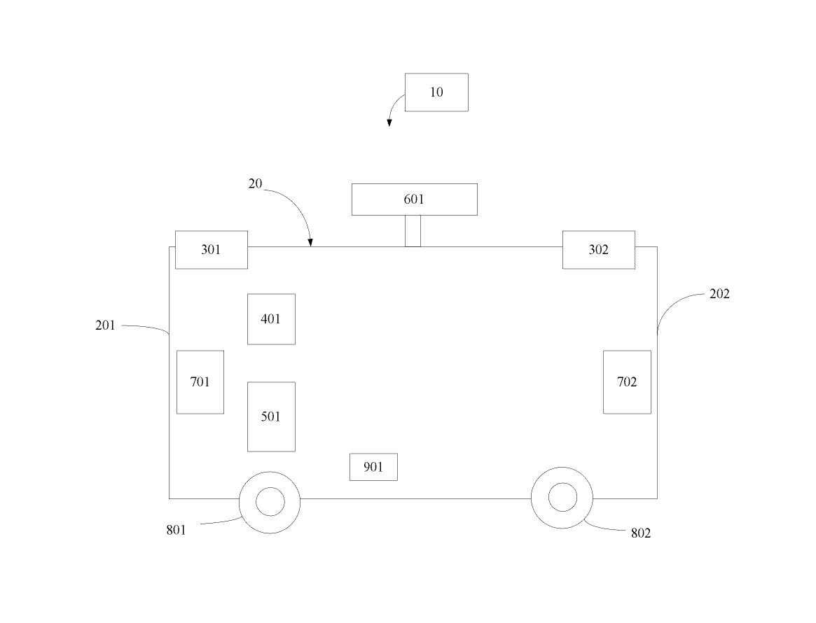

### CROSS-REFERENCE TO RELATED APPLICATIONS

This application claims all benefits accruing under 35 U.S.C. § 119 from Taiwan Patent Application No. 106105931, filed on Feb. 22, 2017, in the Taiwan Intellectual Property Office, the contents of which are hereby incorporated by reference.

### FIELD

The subject matter herein generally relates to an autonomous mobile device.

### BACKGROUND

The current autonomous mobile devices, such as mobile robots, whose positioning navigation technology are classified into indoor positioning navigation and outdoor positioning navigation. When the autonomous mobile devices enter indoors, autonomous mobile devices are primarily navigated through magnetic stripe navigation. In this way, the magnetic stripe navigation needs to be affixed with a magnetic stripe on the driving route in advance, which destroy the original environment and is very inflexible. When autonomous mobile devices get outdoors, autonomous mobile devices are primarily navigated by Global Positioning System (GPS). However, GPS navigation technology is only suitable for outdoor navigation. When the devices get into the room or tunnel, GPS navigation can not accept the GPS signal, and the navigation system can not work.

What is needed, therefore, is to provide an autonomous mobile device which can overcome the shortcomings as described above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

The FIGURE is a schematic view showing base module of an autonomous mobile device provided according to embodiment of the present invention.

### DETAILED DESCRIPTION

It will be appreciated that for simplicity and clarity of illustration, where appropriate, reference numerals have been repeated among the different FIGURES to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The connection can be such that the objects are permanently connected or releasable connected. The term “substantially” is defined to be essentially conforming to the particular dimension, shape or other word that substantially modifies, such that the component need not be exact. The term “comprising” means “including, but not necessarily limited to”; it specifically indicates open-ended inclusion or membership in a so-described combination, group, series and the like. It should be noted that references to “an” or “one” embodiment in this disclosure are not necessarily to the same embodiment, and such references mean at least one.

The present disclosure relates to an autonomous mobile device.

Referring to the FIGURE, an autonomous mobile device according to one embodiment is provided. The autonomous mobile device includes a body 20, two Light Detection and Ranging (LiDAR) devices, a CPU 401, a control terminal 501 and an image detector 601. The body 20 includes a front end 201 and a back end 202. The two LiDAR devices include a front-end LiDAR device 301 and a back-end LiDAR device 302. The front LiDAR device 301 is located on the top of the front end 201 of the body 20, and the back-end LiDAR device 302 is located on the top of the back end 202 of the body 20. The CPU 401 is located on the body 20, and the location of the CPU 401 is not limited. The CPU 401 is configured to control the operation of two LiDAR devices, process the reflection point data collected by the two LiDAR devices, and build 3D modeling and map construction using Simultaneous Localization and Mapping (SLAM) algorithms according to the processed reflection point data. The control terminal 501 is located on the body 20, and the detail location of the control terminal 501 is not limited. The control terminal 501 is used for receiving the information of the CPU 401 and controlling movement of the autonomous mobile device 10. The image detector 601 is located at the top of the body 20 for detecting image information around the autonomous mobile device 10 and transmitting the image information to a remote terminal for remote controlling the autonomous mobile device 10 of the remote terminal.

The body 20 is the hardware of the autonomous mobile device 10 itself. The autonomous mobile device 10 can be a driverless car, a robot, or a transmission vehicle. In one embodiment, the autonomous mobile device 10 is a factory-unmanned transmission vehicle.

The autonomous mobile device 10 can further include at least one ultrasonic sensor located on the front end 201 or the back end 202 of the body 20. When the number of the at least one ultrasonic sensor is one, it is located on the front end 201 of the body 20. When the number of the at least one ultrasonic sensor is two, the two ultrasonic sensors are separately located on the front end 201 and the back end 202 of the body 20. Referring to the FIGURE, in one embodiment, the at least one ultrasonic sensor includes a front-end ultrasonic sensor 701 and a back-end ultrasonic sensor 702. The front-end ultrasonic sensor 701 is located on a lower center of the front end 201 of the body 20. The back-end ultrasonic sensor 702 is located on a lower center of the back end 202 of the body 20. The ultrasonic sensor is used to sense information such as a distance or a size of obstacles around the autonomous mobile device 10, and transmits the information to the control terminal 501. Based on the information provided by the ultrasonic sensor, the autonomous mobile device 10 can avoid obstacles during movement. In other embodiments, the autonomous mobile device 10 can include a plurality of ultrasonic sensors installed in a peripheral position of the body 20 to improve its accuracy and sensitivity to avoid obstacles during the movement.

The autonomous mobile device 10 can further include a driving wheel 801 and an omnidirectional wheel 802. The driving wheel 801 is located below the front end 201 of the body 20. The omnidirectional wheel 802 is located below the back end 202 of the body 20. The driving wheel 801 and the omnidirectional wheel 802 are connected to a motor system (not shown) and controlled by the control terminal 501, so that the autonomous mobile device 10 can flexibly change the moving direction.

The autonomous mobile device 10 can further include a Bluetooth device 901 and a remote control device (not shown). The Bluetooth device 901 is set in the body 20. The remote control device is connected to the autonomous mobile device 10 through the Bluetooth device 901, and remotely control the autonomous mobile device 10.

The autonomous mobile device 10 may can include a wireless base device (not shown). The wireless base device is set in the body 20 and used to establish a local area network. The autonomous mobile device 10 can directly connect with an external computer through its local area network to achieve computer monitoring.

Compared with the prior art, the autonomous mobile device provided by the present invention has the following advantages: first, 3D modeling with LiDAR device and mapping with SLAM algorithm for positioning and navigation of autonomous mobile device enables the autonomous mobile device to have non-specific-environment 3D modeling, precise positioning and navigation from indoor to outdoor without influences. Second, the navigation system of the autonomous mobile device does not need to destroy the original environment, and can control the autonomous mobile device to be flexible in walking. Thirdly, the navigation system of the autonomous mobile device has three-dimensional depth of vision, with obstacle recognition function, and there is no obstacle missing inspection and false reporting.

The embodiments shown and described above are only examples. Even though numerous characteristics and advantages of the present technology have been set forth in the forego description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

Depending on the embodiment, certain of the steps of methods described may be removed, others may be added, and the sequence of steps may be altered. The description and the claims drawn to a method may include some indication in reference to certain steps. However, the indication used is only to be viewed for identification purposes and not as a suggestion as to an order for the steps.

What is claimed is:

1. A autonomous mobile device comprising:
a body comprising a front end and a back end;
two Light Detection and Ranging (LiDAR) devices respectively located on the front end and the back end;
a CPU located in the body, wherein the CPU is configured to control operation of the two LiDAR devices, process reflection point data collected by the two LiDAR devices, and build 3D modeling and map construction using Simultaneous Localization and Mapping (SLAM) algorithms;
a control terminal located on the body and configured to receive information from the CPU and control movement of the autonomous mobile device; and
an image detector located on the body and configured to detect image information around the autonomous mobile device and transmit the image information to a remote terminal for remote controlling on the autonomous mobile device.

2. The autonomous mobile device of claim 1, wherein the two LiDAR devices comprise a front-end LiDAR device and a back-end LiDAR device, the front LiDAR device is located on top of the front end, and the back-end LiDAR device is located on top of the back end.

3. The autonomous mobile device of claim 1, further comprising at least one ultrasonic sensor located on the body and configured to sense information around the autonomous mobile device and transmit the information to the control terminal.

4. The autonomous mobile device of claim 3, wherein the at least one ultrasonic sensor comprises a front-end ultrasonic sensor and a back-end ultrasonic sensor, the front-end ultrasonic sensor is located on a lower center of the front end, the back-end ultrasonic sensor is located on a lower center of the back end.

5. The autonomous mobile device of claim 3, wherein the at least one ultrasonic sensor comprises a plurality of ultrasonic sensors installed in a peripheral position of the body.

6. The autonomous mobile device of claim 1, further comprising a driving wheel and an omnidirectional wheel, wherein the driving wheel is located below the front end, the omnidirectional wheel is located below the back end.

7. The autonomous mobile device of claim 6, wherein the driving wheel and the omnidirectional wheel are connected to a motor system and controlled by the control terminal.

8. The autonomous mobile device of claim 1, further comprising a Bluetooth device and a remote control device.

9. The autonomous mobile device of claim 8, wherein the Bluetooth device is set in the body, the remote control device is connected to the autonomous mobile device through the Bluetooth device.

10. The autonomous mobile device of claim 1, further comprising a wireless base device, wherein the wireless base device is set in the body and configured to establish a local area network.

11. The autonomous mobile device of claim 1, wherein the autonomous mobile device comprises a driverless car, a robot, and a transmission vehicle.
